(19) United States
(12) Patent Application Publication
(10) Pub. No.: US 2026/0241491 A1
(43) Pub. Date: Aug. 20, 2026

(54) METHOD AND SYSTEM FOR CONSTANT-ENERGY LASER-ASSISTED CURVED SURFACE MACHINING, ELECTRONIC APPARATUS, COMPUTER-READABLE STORAGE MEDIUM AND COMPUTER PROGRAM PRODUCT

(71) Applicant: HUAZHONG UNIVERSITY OF SCIENCE AND TECHNOLOGY, Hubei (CN)

(72) Inventors: Jianfeng Xu, Hubei (CN); Chuangting Lin, Hubei (CN); Jianguo Zhang, Hubei (CN); Jiachen Wei, Hubei (CN); Xiao Chen, Hubei (CN); Junfeng Xiao, Hubei (CN)

(73) Assignee: HUAZHONG UNIVERSITY OF SCIENCE AND TECHNOLOGY, Hubei (CN)

(21) Appl. No.: 19/365,103

(22) Filed: Oct. 21, 2025

(30) Foreign Application Priority Data
Feb. 20, 2025 (CN) 202510188640.8

(51) Int. Cl. B23K 26/38

(52) U.S. Cl. CPC B23K 26/38

(57) ABSTRACT

A constant-energy laser-assisted curved surface machining method and system are provided. The method includes: adjusting a tilt angle between a laser beam and an incident surface so that the laser beam is emitted from a rake face of a diamond tool; determining an acting position of a diamond tool arc at each machining point based on a curved surface machining cutting trajectory, to obtain a laser beam offset distance; performing laser focus position compensation based on the laser beam offset distance, so that any machining point receives laser assistance; simulating to obtain a mapping relationship model between laser power and a material softening temperature corresponding to different machining points; obtaining actual laser power required for all machining points based on the mapping relationship model; and performing laser-assisted machining sequentially for all machining points in an area to be machined according to the actual laser power.

### CROSS-REFERENCE TO RELATED APPLICATION

This application claims the priority benefit of China application serial no. 202510188640.8, filed on Feb. 20, 2025. The entirety of the above-mentioned patent application is hereby incorporated by reference herein and made a part of this specification.

### BACKGROUND

### Technical Field

This disclosure belongs to the field of ultra-precision machining, and more specifically, relates to a method and system for constant-energy laser-assisted curved surface machining.

### Description of Related Art

Materials such as monocrystalline silicon and fused quartz are characterized by high hardness, high brittleness, and low fracture toughness, making them typical hard, brittle, and difficult-to-machine materials. When traditional cutting methods are used to process these materials, poor surface quality and severe subsurface damage occur due to brittle fracture of the material. Furthermore, the high cutting forces and unstable cutting process during brittle removal lead to severe tool wear, making it difficult to achieve high-precision machining of large-aperture complex curved optical components. With the development and popularization of laser technology, laser in-situ assisted machining has become an important method for high-precision machining of hard and brittle materials. It primarily utilizes single-point diamond cutting technology to achieve plastic removal of the material, thereby improving surface quality and reducing tool wear.

Current laser in-situ assisted cutting technology faces two major technical challenges in curved surface machining. Firstly, the laser beam is fixed at the center of the diamond tool arc, while the actual cutting point continuously changes along the tool edge during curved surface machining. This results in a lack of effective laser assistance in most machining areas, primarily due to the difficulty in optical path control caused by the flank face are structure and the low energy utilization efficiency of the backward emission mode. Secondly, when constant rotational speed machining is adopted, the scanning linear velocity gradually decreases as the tool moves toward the workpiece center. Under constant laser power, this leads to a sharp increase in heat accumulation and significant local temperature fluctuations, causing uneven material softening and ablation defects. Moreover, excessive heat accumulation increases the risk of graphitization of the diamond tool. These two issues collectively result in large form accuracy deviations and increased subsurface damage depth in curved surface components, severely restricting the improvement of optical component machining quality. In summary, based on existing technologies, there is currently no suitable machining method for the ultra-precision machining of curved optical components made of hard, brittle, and difficult-to-machine materials.

### SUMMARY

Aiming at the shortcomings of existing technology, the purpose of this disclosure is to provide a constant-energy laser-assisted curved surface machining method and system, aiming to solve the problems of large form accuracy deviation and deep subsurface damage in curved surface components caused by existing laser in-situ assisted cutting technology, which makes it difficult to achieve high-precision and low-damage manufacturing.

To achieve the above purpose, in a first aspect, this disclosure provides a constant-energy laser-assisted curved surface machining method, including:
S1: adjusting the tilt angle between the laser beam and the incident surface so that the laser beam is emitted from the rake face of the diamond tool; determining the acting position of the diamond tool arc at each machining point based on the curved surface machining trajectory, and obtaining the laser beam offset distance; performing laser focus position compensation based on the laser beam offset distance to ensure laser assistance at any machining point;
S2: simulating and obtaining a mapping relationship model between laser power and material softening temperature corresponding to different machining points; determining the actual laser power required for all machining points based on the mapping relationship model;
S3: performing laser-assisted machining sequentially for all machining points in the area to be processed according to the actual laser power.

Further, the following relational model is utilized to adjust the tilt angle between the laser beam and the incident surface so that the laser exits from the rake face of the diamond tool:

$$\frac{a}{L} = tan [ β - arcsin ( \frac{sin β}{n} ) ]$$

wherein, β is the laser incidence angle, L is the length of the diamond tool, a is the distance from the upper end of the laser incidence surface to the cutting edge of the diamond tool, and n is the refractive index of diamond.

Furthermore, the method for compensating the laser focus position based on the laser beam offset distance is as follows:
S101: establishing an X-Y distance relationship model for the arc of the diamond tool cutting edge;
S102: based on the X-Y distance relationship model of the diamond tool cutting edge arc, obtaining the compensation value in the Y-direction for the laser focus after the laser beam is offset in the X-direction.
S103: controlling the laser beam to move in the Y-direction according to the compensation value, so that the laser beam coincides with the target processing position.

Furthermore, the X-Y distance relationship model of the diamond tool cutting edge are is expressed as the following model:

$$dy = f ( dx )$$

wherein, dx is the offset distance of the laser beam in the X-direction, and dy is the compensation value of the laser focus in the Y-direction.

Furthermore, the method for obtaining the laser power for all machining points in the area to be processed based on the aforementioned mapping relationship model is as follows.
S201: based on the mapping relationship model, outputting the material softening temperature corresponding to each machining point;
S202: comparing the material softening temperature with the corresponding ideal softening temperature to determine whether the laser power at the current machining point meets the softening requirement: if yes, retaining the current laser power as the actual laser power; if not, adjusting the laser power until the laser power meets the softening requirement is obtained, then stop adjusting.

Furthermore, the laser power is dynamically matched in real time according to the cutting trajectory of the diamond tool until constant-energy auxiliary processing of all machining points is completed.

According to a second aspect of the present disclosure, a system for implementing the constant-energy laser-assisted curved surface machining method as described above. The system includes:
a laser beam adjustment module, configured to adjust the tilt angle between the laser beam and the incident surface so that the laser beam is emitted from the rake face of the diamond tool;
a laser beam offset acquisition module, configured to determine the acting position of the diamond tool are in each machining point based on the curved surface machining trajectory, and obtain the laser beam offset distance;
a laser focus position compensation module, configured to perform laser focus position compensation based on the laser beam offset distance, so that any machining point receives laser assistance;
a laser beam energy control module, configured to simulate and obtain a mapping relationship model between the laser power and the material softening temperature corresponding to different machining points; and also configured to obtain the actual laser power required for all machining points based on the mapping relationship model;
a laser processing module, configured to perform laser-assisted machining sequentially on all machining points in the area to be processed according to the actual laser power;
a multi-directional displacement automatic adjustment platform, configured to integrate the laser beam adjustment module, the laser beam offset acquisition module, the laser focus position compensation module, the laser beam energy control module, and the laser processing module to form a closed-loop control system.

In a third aspect, the disclosure provides an electronic apparatus, including: at least one memory, used to store a program; and at least one processor, used to execute the program stored in the memory. When the program stored in the memory is executed, the processor is used to execute the method according to the first aspect or any possible implementation manner of the first aspect.

In a fourth aspect, the disclosure provides a computer-readable storage medium. The computer-readable storage medium stores a computer program. When the computer program is run on a processor, the processor executes the method according to the first aspect or any possible implementation manner of the first aspect.

In a fifth aspect, the disclosure provides a computer program product. When the computer program product is run on a processor, the processor executes the method according to the first aspect or any possible implementation manner of the first aspect.

It can be understood that the beneficial effects of the second to fourth aspects mentioned above can be found in the relevant description of the first aspect mentioned above, and will not be repeated here.

Generally speaking, compared with the prior art, the above technical solutions in the disclosure has the following beneficial effects:

(1) The constant-energy laser-assisted curved surface machining provided in this disclosure enables the laser beam to emit from the rake face. Compared with traditional emission from the flank face, this approach overcomes the limitations of optical path regulation imposed by the arc structure of the flank face, significantly improving energy utilization efficiency. Based on the constant characteristics of the laser propagation direction, a collaborative control algorithm for beam offset and focus compensation has been developed. This algorithm achieves real-time matching between the laser position and the cutting point of the tool edge during the machining process, ensuring effective laser assistance at any machining position. It addresses issues such as form accuracy deviation and subsurface damage in curved surface components of hard and brittle materials caused by insufficient local softening, thereby improving the surface quality and form accuracy of machined curved optical components made from hard-to-machine brittle materials.

(2) The laser in-situ assisted machining technology provided in this disclosure establishes a dynamic mapping model among machining position, scanning speed, and laser power. By adjusting the power in real time to compensate for the linear velocity attenuation caused by the tool's centripetal motion, the laser energy per unit area remains constant. By constructing a workpiece temperature field distribution model, the laser energy is controlled to avoid uneven material softening or thermal damage that often occurs in traditional constant-power machining, significantly improving machining surface quality and integrity.

(3) The laser in-situ assisted machining system of this application retains the original machining system. It only requires upgrading the laser beam control device in the original in-situ laser-assisted cutting system, replacing the traditional single manual displacement platform with a multi-directional automatic adjustment platform. This is combined with various modules for laser beam pose control and laser beam energy regulation to implement the laser in-situ assisted machining technology described in this disclosure. The overall system structure is simple, enabling real-time tracking of the laser beam with the cutting position, and avoiding adverse effects on the original machining process.

### BRIEF DESCRIPTION OF THE DRAWINGS

FIG. 1 is a schematic flowchart of a constant-energy laser-assisted curved surface machining method according to an embodiment of the present disclosure.

FIG. 2 is a structural schematic diagram of a device for realizing constant-energy laser-assisted curved surface machining according to an embodiment of the present disclosure.

FIG. 3 is a structural schematic diagram of a diamond tool with a laser beam emitted from the tool rake face according to an embodiment of the present disclosure.

FIGS. 4A~4C are schematic diagrams of an optical simulation of laser beam emission from the tool rake face according to an embodiment of the present disclosure.

FIGS. 5A~5C are schematic diagrams of an optical simulation of laser beam emission from the diamond tool rake face after being offset by a certain distance according to an embodiment of the present disclosure.

FIG. 6 is a schematic diagram of laser focus position compensation according to an embodiment of the present disclosure.

FIG. 7 is a schematic flowchart of laser beam energy regulation during the constant-energy laser-assisted curved surface machining process according to an embodiment of the present disclosure.

FIG. 8 is a structural schematic diagram of an electronic device according to an embodiment of the present disclosure.

### DESCRIPTION OF THE EMBODIMENTS

In order to make the purpose, technical solutions and advantages of the present disclosure more clear, the present disclosure will be further described in detail below with reference to the accompanying drawings and embodiments. It should be understood that the specific embodiments described here are only used to explain the present disclosure and are not intended to limit the present disclosure.

The term “and/or” in the present disclosure describes an association relationship between related objects, indicating that there can be three relationships. For example, A and/or B can mean three conditions: A exists alone, A and B exist simultaneously, and B exists alone. The symbol “/” in the present disclosure indicates that the associated objects are in an “or” relationship, for example, A/B means A or B.

The terms “first”, “second”, etc. in the description and claims herein are used to distinguish different objects, rather than to describe a specific order of objects. For example, the first response message and the second response message are used to distinguish different response messages, but are not used to describe a specific sequence of response messages.

In the embodiments of the present disclosure, words such as “exemplary” or “for example” are used to represent examples, illustrations or explanations. Any embodiment or design described as “exemplary” or “such as” in the embodiments of the present application is not to be construed as preferred or advantageous over other embodiments or designs. Rather, use of the words “exemplary” or “such as” is intended to present the concept in a concrete manner.

In the description of the embodiments of the present disclosure, unless otherwise stated, the meaning of “a plurality of” refers to two or more, for example, a plurality of processing units refers to two or more processing units, etc.; a plurality of component refers to two or more components, etc.

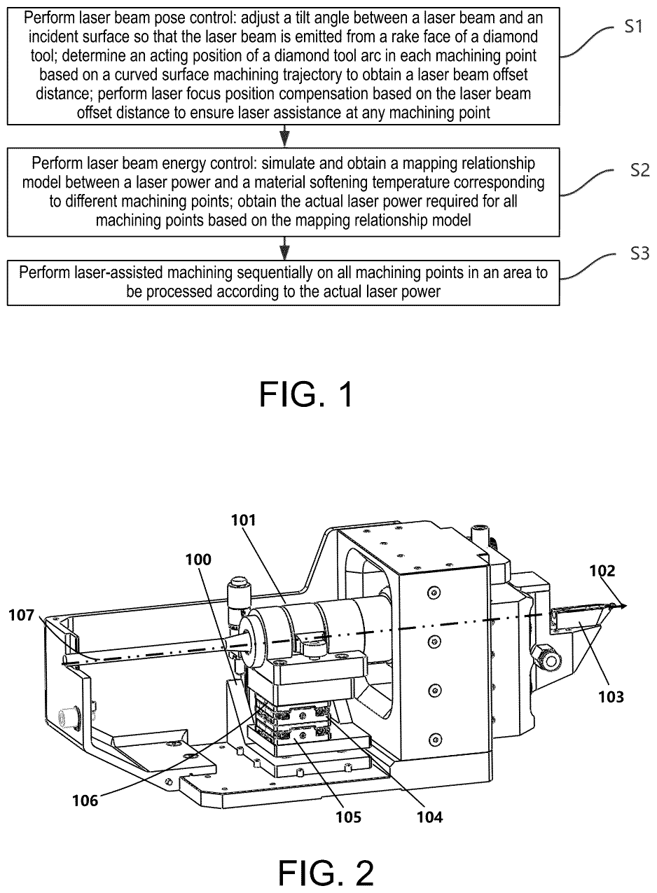

An embodiment of the present disclosure provides a method for constant-energy laser-assisted curved surface machining. As shown in FIG. 1, the method includes the following steps:
S1: performing laser beam pose control first: adjusting the tilt angle between the laser beam and the incident surface so that the laser beam is emitted from the rake face of the diamond tool; determining the acting position of the diamond tool arc in each machining point based on the curved surface machining trajectory to obtain the laser beam offset distance; performing laser focus position compensation based on the laser beam offset distance to ensure laser assistance at any machining point;
S2: then performing laser beam energy control: simulating and obtaining a mapping relationship model between the laser power and the material softening temperature corresponding to different machining points; obtaining the actual laser power required for all machining points based on the mapping relationship model;
S3: performing laser-assisted machining sequentially on all machining points in the area to be processed according to the actual laser power.

In this embodiment, beam energy control must be performed after laser pose control. The pose control ensures that all machining points in the area to be processed are irradiated by the laser, after which the laser energy at each machining point is regulated to ensure consistent laser energy.

FIG. 2 shows a laser in-situ assisted machining device for implementing the above steps S1 to S3. The device includes a displacement platform 100, a beam shaping device 101, a laser beam 102, a diamond tool 103, an X-direction piezoelectric nano-displacement platform 104, a Y-direction piezoelectric nano-displacement platform 105, a pose controller 106, and a laser controller 107. In this embodiment, the laser beam 102 is collimated and focused through the beam shaping device 101 and then emitted from the arc area of the diamond tool 103; the beam shaping device 101 is installed on the displacement platform 100, the X-direction piezoelectric nano-displacement platform 104, and the Y-direction piezoelectric nano-displacement platform 105. During laser beam pose control, the offset of the laser beam is achieved by the X-direction piezoelectric nano-displacement platform 104, and the laser focus position compensation is achieved by the Y-direction piezoelectric nano-displacement platform 105. The pose controller 106 is used to control the movement of the X-direction and Y-direction piezoelectric nano-displacement platforms (104, 105). During laser beam energy control, the laser power is regulated by the laser controller 107. The above machining device is equipped with a constant-energy laser-assisted curved surface machining system, which enables constant-energy laser assistance during the curved surface machining process, specifically including laser beam pose control and laser beam energy control.

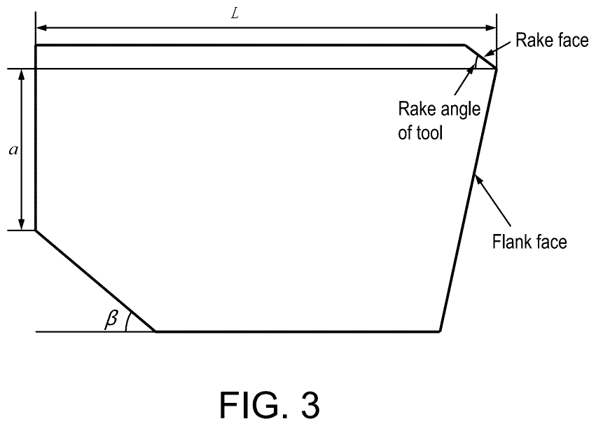

As shown in FIG. 3, which is a schematic diagram of the diamond tool structure in step S1, this embodiment mainly designs the diamond tool through the following relational model. Specifically, the tilt angle β between the laser beam and its incident surface in the diamond tool is adjusted to allow the laser to emit from the rake face of the diamond tool:

$$\frac{a}{L} = tan [ β - arcsin ( \frac{sin β}{n} ) ] \qquad ( 1 )$$

wherein, β is the angle between the laser and its incident surface, L is the length of the diamond tool, a is the distance from the upper end of the laser incident surface to the cutting edge of the diamond tool, and n is the refractive index of diamond.

For example, when the rake angle of the diamond tool is −35°, setting β to 40° ensures that the laser beam is emitted from the tool rake face. Meanwhile, the above relational model guarantees a wide adjustment range for the laser beam and improves laser energy utilization efficiency.

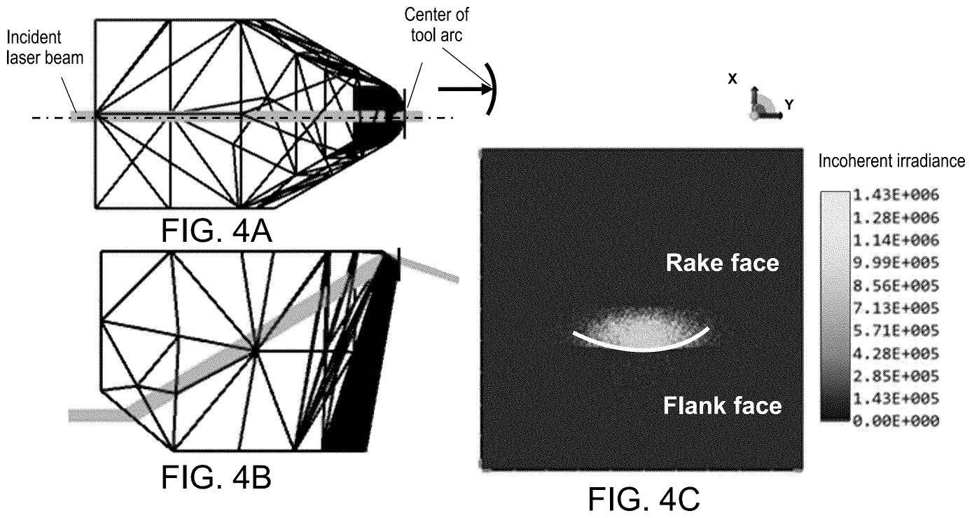

As shown in FIG. 4A and FIG. 4B, which are schematic diagrams of the optical simulation of the laser beam emitted from the rake face of the diamond tool, FIG. 4A is a top view of the diamond tool, and FIG. 4B is a front view of the diamond tool. Specifically, after completing the structural design of the diamond tool according to the aforementioned formula (1), optical simulation is performed using the non-sequential module of Zemax optical simulation software. The laser beam was incident from the center of the surface at a height of 0.6 mm from the bottom surface of the diamond tool. The laser beam undergoes refraction and reflection within the diamond tool and is emitted from the center of the tool rake face.

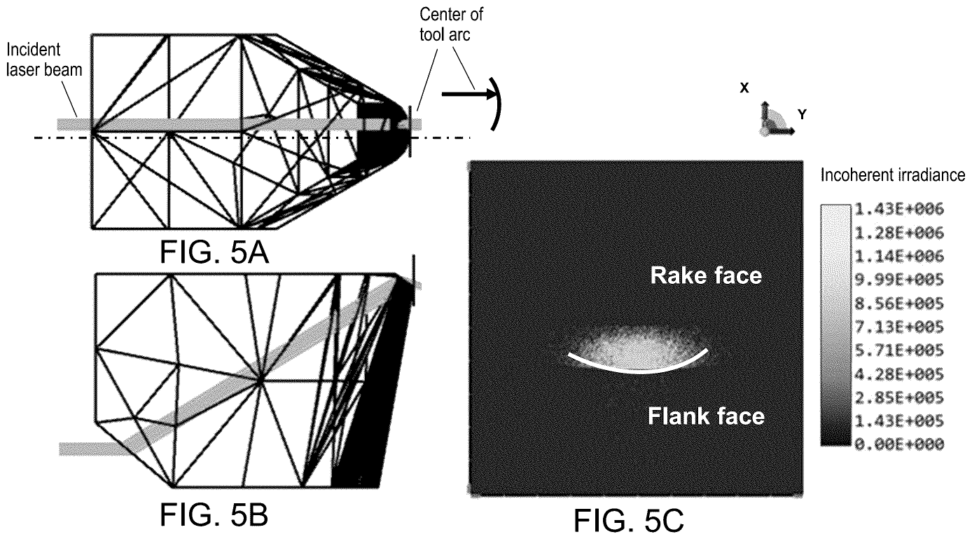

As shown in FIG. 5A and FIG. 5B, which are schematic diagrams of the optical simulation of the laser beam emitted from the rake face of the diamond tool after being offset by a certain distance, FIG. 5A is a top view of the diamond tool, and FIG. 5B is a front view of the diamond tool. Specifically, in the Zemax software, the laser beam is incident into the diamond tool after being offset by 0.15 mm in the X-direction.

As can be seen from the simulation results in FIG. 4C and FIG. 5C, the propagation path of the laser beam after offset in this disclosure is consistent with that before offset (FIG. 4C). Moreover, from FIG. 4C and FIG. 5C, it can be observed that the incoherent irradiance of the laser beam remains unchanged before and after the offset. The position where the offset laser beam emits from the tool rake face is 0.15 mm away from the central axis of the tool arc, meaning the distance between the incident laser and the central axis of the tool arc is the offset distance of the laser beam in the X-direction. Based on the characteristic that the propagation path of the offset laser beam remains unchanged when emitted from the tool rake face, it can be concluded that the pose control of the laser beam can be achieved by moving the laser beam.

After the aforementioned laser beam is offset, the laser focus position changes due to the arc-shaped rake face of the diamond tool. Therefore, it is necessary to establish an X-Y distance relationship model for the tool edge arc. Based on the offset distance of the laser beam in the X-direction, the compensation value for the laser focus in the Y-direction is obtained, and the laser focus position is compensated by moving the laser beam in the Y-direction.

Specifically, the steps of the method for compensating the laser focus position based on the laser beam offset distance include:
S101: establishing an X-Y distance relationship model for the diamond tool cutting edge arc:

In this embodiment, the X-Y distance relationship model of the diamond tool cutting edge arc is expressed as:

$$dy = f ( dx ) \qquad ( 2 )$$

wherein, dx is the offset distance of the laser beam in the X-direction, and dy is the compensation value of the laser focus in the Y-direction.

In other preferred embodiments, the X-Y distance relationship model of the diamond tool cutting edge arc may be refined into other forms.
S102: based on the X-Y distance relationship model of the diamond tool cutting edge arc, obtaining the compensation value in the Y-direction for the laser focus after the laser beam is offset in the X-direction.
S103: controlling the laser beam to move in the Y-direction according to the compensation value, so that the laser beam coincides with the target machining position, thereby achieving laser assistance at any machining point during the curved surface machining process.

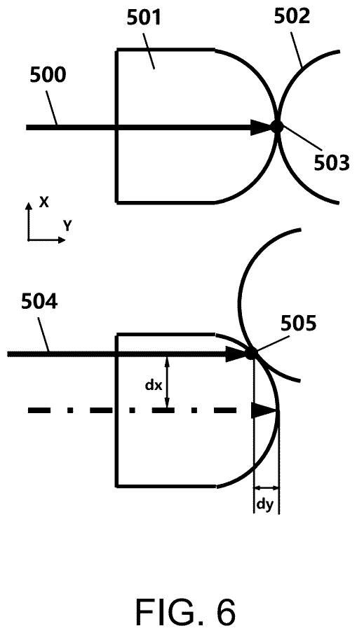

As shown in FIG. 6, which is a schematic diagram of laser focus position compensation. Specifically, for the machining center position 503 on the machined surface 502, the laser beam 500 is incident from the center of the diamond tool 501. After refraction and reflection within the diamond tool 501, the laser beam 500 is emitted from the center of the tool rake face. For other machining positions 505 on the machined surface 502, the laser beam needs to be offset by a certain distance. The offset distance of the laser beam is set as dx. After the offset laser beam 504 undergoes refraction and reflection within the diamond tool 501, it is emitted from the tool rake face and acts on the other machining positions 505 on the machined surface 502.

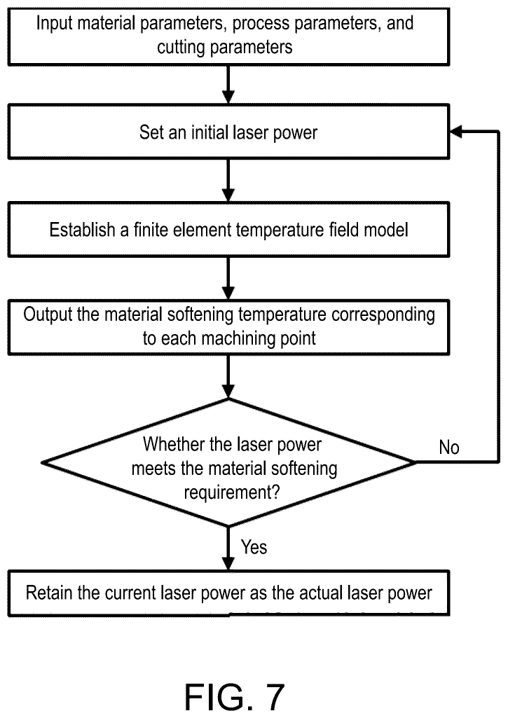

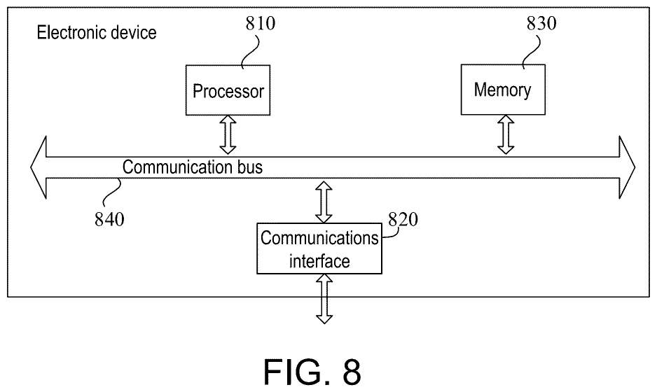

In step S2, the methodological flow for simulating and obtaining the mapping relationship model between the laser power and the material softening temperature corresponding to different machining points is shown in FIG. 7. The specific steps are as follows: First, establishing a temperature field model (i.e., the mapping relationship model) under laser-assistance in finite element software. Specifically, inputting material parameters, process parameters, and cutting parameters of the surface to be machined, setting the initial laser power, and then obtaining the relationship between the laser power and the output softening temperature at different machining positions. The formula of the temperature field model is:

$$T = G ( v , x , y , P ) \qquad ( 3 )$$

wherein T is the material softening temperature, v is the machining speed, x is the machining position of the machining point along the x-axis direction, y is the machining position of the machining point along the y-axis direction, and P is the laser power.

Specifically, the method for obtaining the laser power for all machining points in the area to be processed based on the aforementioned mapping relationship model is as follows:
S201: based on the mapping relationship model, outputting the material softening temperature corresponding to each machining point;
S202: comparing the material softening temperature with the corresponding ideal softening temperature to determine whether the laser power at the current machining point meets the softening requirement: if yes, retaining the current laser power as the actual laser power; if not, adjusting the laser power until the laser power meets the softening requirement is obtained, then stop adjusting.

In step S3, the laser power is dynamically matched in real-time with the cutting trajectory of the diamond tool until constant-energy assisted machining is completed for all machining points. Specifically, the in-situ assisted machining CNC system and the laser are controlled in coordination to achieve real-time dynamic matching of the actual laser power with the cutting path of the diamond tool, thereby enabling constant-energy assisted machining and ensuring the integrity of curved surface processing.

Another embodiment also provides a system for applying the method for constant-energy laser-assisted curved surface machining as described above. The system includes:
a laser beam adjustment module, configured to adjust the tilt angle between the laser beam and the incident surface so that the laser beam is emitted from the rake face of the diamond tool;
a laser beam offset acquisition module, configured to determine the acting position of the diamond tool arc in each machining point based on the curved surface machining trajectory, and obtain the laser beam offset distance;
a laser focus position compensation module, configured to perform laser focus position compensation based on the laser beam offset distance, so that any machining point receives laser assistance;
a laser beam energy control module, configured to simulate and obtain a mapping relationship model between the laser power and the material softening temperature corresponding to different machining points; and also configured to obtain the actual laser power required for all machining points based on the mapping relationship model;
a laser processing module, configured to perform laser-assisted machining sequentially on all machining points in the area to be processed according to the actual laser power;
a multi-directional displacement automatic adjustment platform, configured to integrate the laser beam adjustment module, the laser beam offset acquisition module, the laser focus position compensation module, the laser beam energy control module, and the laser processing module to form a closed-loop control system. Specifically, the multi-directional automatic displacement platform can receive control commands from the aforementioned modules, synchronously adjust the spatial position of optical components and the motion trajectory of the tool, and feedback physical parameters such as platform displacement and acceleration to the control layer. More specifically, the multi-directional automatic displacement platform integrates a five-axis motion mechanism (XYZ linear axes+AB rotary axes) and corresponding linear motors to achieve multi-directional displacement.

It is understandable that the detailed functional implementation of each unit/module mentioned above can be referred to the descriptions in the preceding method embodiments and will not be reiterated here.

It should be understood that the above system is used to execute the method in the above embodiment. The corresponding program modules in the system have implementation principles and technical effects similar to those described in the above method. For the working process of the system, reference may be made to the corresponding process in the above method, which will not be described again here.

Based on the method described in the above embodiments, an embodiment of the present application provides an electronic device. The electronic device includes: a processor 810, a communications interface 820, a memory 830, and a communication bus 840. The processor 810, the communications interface 820, and the memory 830 communicate with each other via the communication bus 840. The processor 810 can invoke logical instructions stored in the memory 830 to execute the method described in the above embodiments.

Furthermore, the logical instructions in the memory 830 may be implemented in the form of a software functional unit and, when sold or used as a standalone product, may be stored in a computer-readable storage medium. Based on this understanding, the essence of the technical solution of the present application, or the part contributing to the prior art, or part of the technical solution may be embodied in the form of a software product. This computer software product is stored in a storage medium and includes instructions for causing a computer device (which may be a personal computer, a server, or a network device, etc.) to perform all or part of the steps of the method described in the various embodiments of the present application.

Based on the method in the above embodiment, an embodiment of the disclosure provides a computer-readable storage medium. The computer-readable storage medium stores a computer program. When the computer program is run on a processor, the processor executes the method in the above embodiment.

Based on the method in the above embodiment, an embodiment of the disclosure provides a computer program product, when the computer program product is executed by a processor, the processor performs the method in the above embodiment.

It can be understood that the processor in the embodiment of the disclosure may be a central processing unit (CPU), other general-purpose processors, digital signal processors (DSP), application specific integrated circuits (ASIC), field programmable gate arrays (FPGA), other programmable logic devices, transistor logic devices, hardware components, or any combination thereof. The general-purpose processor may be a microprocessor or any conventional processor.

The steps of the method in the embodiment of the disclosure may be implemented through hardware or by a processor executing a software command. The software command may be composed of a corresponding software module. The software module may be stored in a random access memory (RAM), a flash memory, a read-only memory (ROM), a programmable ROM (PROM), an erasable PROM (EPROM), an electrically EPROM (EEPROM), a register, a hard disk, a mobile hard disk, a CD-ROM, or any other form of storage medium well-known in the art. An exemplary storage medium is coupled to the processor, so that the processor can read information from the storage medium and write information to the storage medium. Of course, the storage medium may also be an integral part of the processor. The processor and the storage medium may be located in the ASIC.

The above embodiments may be implemented in whole or in part by software, hardware, firmware, or any combination thereof. When implemented using software, the embodiments may be implemented in whole or in part in the form of a computer program product. The computer program product includes one or more computer commands. When the computer program commands are loaded and executed on a computer, processes or functions described according to the embodiments of the disclosure are generated in whole or in part. The computer may be a general-purpose computer, a specific-purpose computer, a computer network, or other programmable systems. The computer command may be stored in a computer-readable storage medium or transmitted through the computer-readable storage medium. The computer command may be transmitted from one website, computer, server, or data center to another website, computer, server, or data center through wired (for example, coaxial cable, optical fiber, and digital subscriber line (DSL)) or wireless (for example, infrared, wireless, microwave, etc.) means. The computer-readable storage medium may be any available medium that can be accessed by a computer or a data storage apparatus such as a server or a data center including one or more available media. The available media may be magnetic media (for example, floppy disk, hard disk, and magnetic tape), optical media (for example, DVD), semiconductor media (for example, solid state disk (SSD)), etc.

It can be understood that various reference numerals involved in the embodiments of the disclosure are only for convenience of description and are not used to limit the scope of the embodiments of the disclosure.

It is easy for persons skilled in the art to understand that the above descriptions are only preferred embodiments of the disclosure and are not intended to limit the disclosure. Any modifications, equivalent substitutions, improvements, etc., made within the spirit and principles of the disclosure should be included in the protection scope of the disclosure.

What is claimed is:

1. A method for constant-energy laser-assisted curved surface machining, comprising:
S1: utilizing a following relational model to adjust a tilt angle between a laser beam and an incident surface so that the laser exits from a rake face of a diamond tool:
$$\frac{a}{L} = tan [ β - arcsin ( \frac{sin β}{n} ) ]$$
wherein β is a laser incidence angle, L is a length of the diamond tool, a is a distance from an upper end of the laser incidence surface to a cutting edge of the diamond tool, and n is a refractive index of diamond;
determining a acting position of an arc of the diamond tool at each of machining points based on a curved surface machining trajectory, and obtaining a laser beam offset distance; performing laser focus position compensation based on the laser beam offset distance:
S101: establishing an X-Y distance relationship model of the arc of the cutting edge of the diamond tool;
S102: based on the X-Y distance relationship model of the arc of the cutting edge of the diamond tool, obtaining a compensation value in a Y-direction for a laser focus after the laser beam is offset in a X-direction;
S103: controlling the laser beam to move in the Y-direction according to the compensation value, so that the laser beam coincides with the target processing position to ensure laser assistance at any of the machining points;
S2: simulating and obtaining a mapping relationship model between laser power and material softening temperature corresponding to different machining points,
wherein the temperature field model is:
$$T = G ( v , x , y , P )$$
wherein T is a material softening temperature, v is a machining speed, x is a machining position of the machining point along the X direction, y is a machining position of the machining point along the Y direction, and P is the laser power;
determining actual laser power required for all of the machining points based on the mapping relationship model:
S201: based on the mapping relationship model, outputting the material softening temperature corresponding to each of the machining points;
S202: comparing the material softening temperature with a corresponding ideal softening temperature to determine whether the laser power at a current machining point meets a softening requirement: if yes, retaining the current laser power as an actual laser power; if not, adjusting the laser power until the laser power meets the softening requirement is obtained, then stop adjusting;
S3: matching the actual laser power dynamically in real time according to the cutting trajectory of the diamond tool until constant-energy auxiliary processing of all of the machining points is completed.

2. The method for constant-energy laser-assisted curved surface machining according to claim 1, wherein in S1, the X-Y distance relationship model of the arc of the cutting edge of the diamond tool is expressed as:
$$dy = f ( dx )$$
in dx is the offset distance of the laser beam in the X-direction, and dy is the compensation value of the laser focus in the Y-direction.

3. A system for applying constant-energy laser-assisted curved surface machining according to claim 1, comprising:
a laser beam adjustment module, configured to adjust the tilt angle between the laser beam and the incident surface so that the laser beam is emitted from the rake face of the diamond tool;
a laser beam offset acquisition module, configured to determine the acting position of the are of the diamond tool in each of the machining points based on the curved surface machining trajectory, and obtain the laser beam offset distance;
a laser focus position compensation module, configured to perform laser focus position compensation based on the laser beam offset distance, so that any of the machining points receives laser assistance;
the mapping relationship model between the laser power and the material softening temperature corresponding to different machining points; and also configured to obtain the actual laser power required for all of the machining points based on the mapping relationship model;
a laser processing module, configured to perform laser-assisted machining sequentially on all of the machining points in an area to be processed according to the actual laser power;

4. A system for applying constant-energy laser-assisted curved surface machining according to claim 2, comprising:
a laser beam adjustment module, configured to adjust the tilt angle between the laser beam and the incident surface so that the laser beam is emitted from the rake face of the diamond tool;
a laser beam offset acquisition module, configured to determine the acting position of the are of the diamond tool in each of the machining points based on the curved surface machining trajectory, and obtain the laser beam offset distance;
a laser focus position compensation module, configured to perform laser focus position compensation based on the laser beam offset distance, so that any of the machining points receives laser assistance;
the mapping relationship model between the laser power and the material softening temperature corresponding to different machining points; and also configured to obtain the actual laser power required for all of the machining points based on the mapping relationship model;
of the machining points in an area to be processed according to the actual laser power;
a multi-directional displacement automatic adjustment platform, configured to integrate the laser beam adjustment module, the laser beam offset acquisition module, the laser focus position compensation module, the laser beam energy control module, and the laser processing module to form a closed-loop control system.

5. An electronic apparatus, comprising:
at least one memory, configured to store a computer program;
at least one processor, configured to execute the program stored in the memory, wherein when the program stored in the memory is executed, the processor is used to execute the method according to claim 1.

6. An electronic apparatus, comprising:
at least one memory, configured to store a computer program;
at least one processor, configured to execute the program stored in the memory, wherein when the program stored in the memory is executed, the processor is used to execute the method according to claim 2.

7. A computer-readable storage medium storing a computer program, wherein when the computer program is executed by a processor, the processor performs the method according to claim 1.

8. A computer-readable storage medium storing a computer program, wherein when the computer program is executed by a processor, the processor performs the method according to claim 2.

9. A computer program product, wherein, when the computer program product is executed by a processor, the processor performs the method according to claim 1.

10. A computer program product, wherein, when the computer program product is executed by a processor, the processor performs the method according to claim 2.
